(19) United States
(12) Patent Application Publication
(10) Pub. No.: US 2022/0161268 A1
(43) Pub. Date: May 26, 2022

(54) MULTIFUNCTIONAL EXTRUDING-SHEARING MACHINE AND APPLICATION OF SAME

(71) Applicant: Zhengzhou Hongli Agricultural Science and Technology Co. LTD, Zhengzhou (CN)

(72) Inventor: Hongfu WANG, Zhengzhou (CN)

(21) Appl. No.: 17/670,405

(22) Filed: Feb. 11, 2022

Related U.S. Application Data
(63) Continuation of application No. PCT/CN2020/140469, filed on Dec. 29, 2020.

(30) Foreign Application Priority Data
Mar. 5, 2020 (CN) 2020101485293

(51) Int. Cl. B02C 13/22; B02C 13/28; B02C 13/06

(52) U.S. Cl. CPC B02C 13/22; B02C 13/06; B02C 13/2804

(57) ABSTRACT

A multifunctional extruding-shearing machine and an application of the machine is disclosed. The main technical feature of the machine is that the outer surface of the wear-resistant component made of hard alloy on the rotor pin and stator pin is covered with 4-12 step teeth, and the surface of the step teeth of the stator pin faces the inside and the surface of the step teeth of the stator pin faces outside when the equipment is assembled, and the rotor pin wear-resistant member tip faces the stator pin wear-resistant member tip. The above structural features ensure that the rotor pin and the stator pin can clamp the material particles and exert extrusion shear force on them to force them to be crushed.

### TECHNICAL FIELD

The present disclosure relates to the technical field of grinding, crushing and shelling equipment, and more specifically, to a multifunctional extruding-shearing machine and an application of the machine.

### BACKGROUND ART

Powder engineering divides crushing equipment into two categories of crushing equipment and grinding equipment. The particle size of finished products of crushing equipment is more than 1 mm. The particle size of finished products of grinding equipment is less than 1 mm. Shelling equipment is a special crushing equipment. The function of shelling equipment is to peel off the hard shell of incoming materials (usually plant fruits), and most of them require no or less damage to seeds or nuts.

There are four kinds of crushing methods summarized by powder engineering: extrusion crushing, impact crushing, friction shearing crushing and splitting crushing. There is no record of squeezing and crushing in all technical documents before 2015, and there is no extruding-shearing and crushing machine in domestic and foreign markets.

Chinese disclosure patent number 201579322.3, the patent name is the patent of high-speed extruding-shearing grinder (the patent of the inventor of the present application), and a kind of equipment with extrusion, cutting and crushing functions is disclosed. The main technical feature claimed in claim 1 of the patent is the wear-resistant member whose outer surface is V-shaped. The two smooth surfaces at the front of the wear-resistant member only have the function of guiding the materials to converge to the two sides of the pillar pin, without the function of extruding-shearing and crushing. This technical scheme not only reduces the crushing function and effect of the equipment, but also limits the application range of the equipment to the range of crushing 2 mm˜6 mm material particles into powder. This machine is incapable of grinding or crushing 6 mm˜50 mm with large particles, and has no peeling and shelling function.

According to the working principle, the inventor classified ten kinds of grinding machines recorded in Powder Engineering and Equipment into three categories: rolling grinding equipment (wheel mill, roller mill, Lecher mill, vertical mill and raymond mill), impact grinding equipment (cage mill and high-speed impact mill) and medium impact grinding equipment (ball mill, vibration mill and stirring mill). Rolling grinding equipment mainly grinds materials by grinding pressure. Because of the huge rolling force and the long grinding time (usually in seconds), the temperature of the equipment and the ground material rises, and the grinding efficiency is low. Impact grinding equipment achieves the purpose of grinding materials by impacting the materials in the cylinder with high-speed moving hammers, rods, plates and other components. The mechanism of impact grinding is that the kinetic energy transferred from the rotor component to the material particles exceeds the binding energy of the material particles, that is, the material particles are broken. As the material particles can move freely under the impact force, a considerable part of the kinetic energy of the equipment components is consumed to push the material particles to move. The structure determines that the rotor rotates once, and the materials that the rotor members can contact only account for a dozen to dozens of times of the materials in the cylinder, and besides, most of the materials that are in contact with the rotor members can't be crushed, so most of the kinetic energy of the rotor is used for useless work. In addition to moving the material, the useless work also appears in the temperature rise of the material and the equipment. It takes tens of hundreds of impacts of rotor components to crush materials, and the resulting energy consumption is usually the main cause of high energy consumption and low efficiency of equipment. The media impact crushing equipment is that the cylinder or rotor rotates to drive the media to move, and the media impacts and grinds the materials to achieve the purpose of crushing the materials. The medium impact crushing equipment represented by ball mill is a low-efficiency grinding equipment (the effective kinetic energy utilization rate is about 2%) recognized by the existing technical data. In addition to the above-mentioned reasons leading to the low efficiency of the ball mill, the motor-driven operation of a mill loaded with tens of tons of media consumes a large amount of electric energy is another important reason.

There are five kinds of crushing machines recorded in the book “Powder Engineering and Equipment”: jaw crusher, cone crusher, roller crusher, hammer crusher and impact crusher. Wherein, hammer crusher and cone crusher are mostly used for bulk materials which can't be processed by the present disclosure, while the roller crusher is the same as the roller mill in the grinding machine, but the rolling distance of the latter is obviously larger than that of the former; and the hammer crusher is the same machine with the high-speed impact grinding in the grinding machine structure and the same work principle, but the latter with the screen hole diameter is obviously larger than the former. According to this analysis, the defects of the existing crushing machinery should be exactly the same as the corresponding grinding machinery.

At present, there are four basic methods of shelling at home and abroad: rubbing, impact, roller extrusion and blade cutting. The existing disk huller, centrifugal huller, roller crusher and knife plate huller can basically meet the hulling needs of peanuts, sunflower seeds, castor seeds, cotton seeds and other equipment. However, there is virtually no machinery available on that market for effectively remove the husks of hickory nut and camellia seeds with hard husks and difference in shape and size. Many oil extraction plants also have to crush the inner shell together with the nuts to extract oil. This helpless action leads to the occurrence and long-term existence of such major defects as low oil output rate, low economic benefit and waste of valuable resources.

Therefore, how to provide a multifunctional extruding-shearing machine which can be used for grinding, granulating and shelling is an urgent problem to be solved by technicians in this field.

### SUMMARY

In view of the above, the present disclosure provides a multifunctional extruding-shearing machine and an application of the same, which can process almost all solid materials with particle size less than 50 mm, except rubber, soft plastics and other materials with high toughness and plasticity, into powder materials at one time with high efficiency and low consumption; it is a multifunctional extruding-shearing machine that can peel the shells of walnut, camellia seed, almond, peach kernel and other plant fruits with high efficiency and low consumption.

In order to achieve the above purpose, the present disclosure adopts the following technical scheme:

a multifunctional extruding-shearing machine includes a motor, a casing, a rotor part, a stator component-cum-cover plate and a base, wherein the casing is fixed on a flange plate of the motor and the motor is fixed on the base;

the rotor part includes a hub, a rotor disk and rotor pins fixed on the hub, wherein, the rotor pins are uniformly distributed and installed or welded on the rotor disk for 1-3 turns along a circumferential direction with an axis of the rotor disk as a center, and each turn is provided with a number of the rotor pins; the rotor disk is arranged in the casing and fixed on a rotating shaft of the motor through the hub;

the stator component-cum-cover plate includes a stator disk and stator pins, wherein, the stator pins are uniformly distributed and installed or welded on the stator disk for 1-3 turns along a circumferential direction with an axis of the stator disk as a center, and each turn is provided with a plurality of the stator pins; the center of the stator component-cum-cover plate is provided with a feed port, and the stator component-cum-cover plate is fixed on the face of the casing;

the rotor pins and the stator pins have the same structure, and both of them include a quadrangular prismatic pin billet with a square cross section, and the pin billet is provided with a screw or polished rod connected with the rotor disk or the stator disk; there are two surface welded or bonded wear-resistant members in a direct contact with a material on the quadrangular prismatic pin billet;

an inner horizontal surface and a vertical surface of the wear-resistant member are smooth planes, an outer upper surface of the wear-resistant member is composed of several stepped teeth, a lower surface is composed of a right-angle table and a smooth inclined plane, a smooth inclined plane of the lower surface merges with a lowest stepped surface of an upper surface in a spire shape, and a junction is a transition of an arc surface; a stepped tooth surface of the stator pin mounted on the stator component-cum-cover plate faces inward, a stepped tooth surface of the rotor pin mounted on the rotor part faces outward, and the stepped tooth tip of the rotor pin is disposed opposite to the stepped tooth tip of the stator pin.

Preferably, in the above-mentioned multifunctional extruding-shearing machine, a projected area of the upper surface on the outer side of the wear-resistant member in a vertical section passing through an axis of the pin billet is more than three times that of the lower surface.

Preferably, in the above-mentioned multifunctional extruding-shearing machine, the number of step teeth on the outer upper surface of the wear-resistant member is 4-12.

Preferably, in the above-mentioned multifunctional extruding-shearing machine, the wear-resistant member is made of a cemented carbide or a special ceramic superhard wear-resistant material.

An application of a multifunctional extruding-shearing machine in a grinding equipment, a gap between the rotor pin and the stator pin is L, and the value of L is between 0.2 mm and 1.5 mm; a linear velocity v of the rotor pin is between 50 m/s and 150 m/s.

An application of a multifunctional extruding-shearing machine in a crushing equipment, the value L of the gap between the rotor pin and the stator pin is equal to a product particle size value required by design; the linear velocity v of the rotor pin is between 5 m/s and 30 m/s.

An application of a multifunctional extruding-shearing machine, the value L of the gap between the rotor pin and the stator pin is equal to a maximum kernel diameter value of plants to be processed; the linear velocity v of the rotor pin is between 2 m/s and 10 m/s.

The working principle of the present disclosure is that the rotor pin and the stator pin clamp the material particles and apply a squeezing shear force to them to force the material particles to break up. The technical features of the disclosure ensure that the structure and working principle of the disclosure have the following advantages compared with the prior art:

As shown in FIG. 5, the forces excited on the material particles by the rotor and stator pins of the present disclosure are standard compressive and shear forces. The high-speed extruding-shearing and crushing machine and the disclosure exploit a new and high-efficiency pulverizing mode-extrusion pulverizing mode.

According to the dynamic formula, it can be calculated that each rotor pin of the present disclosure for grinding has a kinetic energy as high as several tens to several tens of thousands of joules (the kinetic energy of the entire rotor is the kinetic energy of each rotor pin, this is determined by the structure of the equipment). The rotor pin has kinetic energy far exceeding the binding energy of material particles, which makes the disclosure have a strong crushing function.

If the process of a rotor pin from approaching to leaving any stator pin is regarded as a pin extruding-shearing and crushing operation (hereinafter referred to as pin crushing), it can be calculated that the time consumed by the primary pin crushing operation of the present disclosure for grinding is only tens of microseconds. Obviously, the short working time is an important guarantee for the high efficiency of the disclosure.

As shown in FIG. 5, the upper surface of the wear-resistant member is all characterized by stepped teeth, which ensures that the stepped teeth at the front end of the pin can crush the material particles after clamping them. In addition, by appropriately increasing the clearance between the rotor pin and the stator pin and greatly reducing the linear speed of the rotor pin, the extrusion cutter with the function of controlling the particle size of the finished product and shelling can be designed and produced.

If the analysis is divided into two or four according to the result of shear crushing, as shown in FIG. 5, the state after the front step teeth of the rotor pin and the stator pin clamp and crush the large particles should be shown in FIGS. 6-7. When the rotor pin moves gradually closer to the stator pin along the circumferential direction, the process of each step tooth on the rotor pin wear-resistant member from approaching to leaving each step of the stator pin wear-resistant member is a crushing operation (hereinafter, each pair of step teeth is called a crushing operation). According to the second and third analysis, every extruding-shearing and crushing must have excellent crushing effect. Assuming that a wear-resistant member has 6 stepped teeth, one crushing of the pin includes 36 crushing times. According to the calculation of 100 rotor pins and 150 stator pins used in an extruding-shearing machine, one rotation of the rotor can form 15,000 times of the pin crushing. These pin crushing includes 540,000 times of extrusion crushing. If calculated according to the rotating speed 2900 r/min of the extruding-shearing machine, 43.5 million times of the pin crushing will be formed in one minute when the disclosure is in operation. These pin crushing includes 156.6 million extrusion crushing times. Obviously, the shape of the wear-resistant member and the structural features of the present disclosure determine that the present disclosure can be operated for one minute to form hundreds of millions of extruding-shearing and crushing! Obviously, this is another important guarantee for the great advantages of high efficiency and energy saving of the present disclosure.

The projected area of the outer upper surface of the designed wear-resistant member in the vertical section passing through the axis of the pin billet is more than three times that of the lower surface. The ability of the upper surface to guide the aggregated material particles is ¼ higher than that of the high-speed extruding-shearing machine, that is to increase the probability of crushing the material particles into the machine by ¼. This is also an important guarantee for the high efficiency of the disclosure.

According to the prototype test of the disclosure with only two rings of rotor pins and stator pins installed, the crushing ratio of one-time processing is close to 100 analysis, and the crushing ratio of one-time extrusion crushing according to the above-mentioned article five is definitely much larger than the previously assumed split into two or four. According to the two rounds of pins, it is decided that each material particle entering the casing can only be crushed by pins twice, and according to the analysis that the crushing ratio of one extrusion crushing reaches six, a material particle can only be crushed by extrusion twice in one pin crushing. According to the above analysis and calculation, the crushing ratio of each extruding-shearing and crushing of the present disclosure should be around 20.

8. In the present disclosure, the wear-resistant component is made of superhard wear-resistant material such as hard alloy or special ceramic, and the service life of the disclosure is 3 to 5 time longer than that of the prior similar equipment.

According to the above-mentioned advantages of the working principle of the disclosure, it can be inferred from analysis that the application advantages of the disclosure are:

It is inferred from the analysis that the shear strength of all solid materials is less than half of the compressive strength, that the power consumption of the present disclosure for crushing the same amount of material is at least 30% less than that of all existing crushing equipment.

The huge kinetic energy possessed by the rotor column pin according to the disclosure enables the disclosure to have a strong crushing function analysis inference, and the application range of the disclosure is far wider than that of all existing comminution equipment. Theoretically, it can process almost all solid material particles with particle size less than 50 mm into powder materials at one time with high efficiency and low consumption, except rubber, soft plastics and other materials with high toughness and plasticity.

According to the comparative analysis of the structural features and working principle of the present disclosure and the existing crushing equipment, the present disclosure has the potential to replace most of the existing grinding and crushing equipment. At the same time, it has the advantages of simple structure, low price, small floor space and convenient installation and maintenance.

According to the advantage analysis of the working principle of the present disclosure discussed earlier, it is inferred that the present disclosure has great advantages of high efficiency and energy saving when replacing any kind of existing grinding equipment.

In the present disclosure, the only consumable part of the disclosure is the pin billet.

According to the structure and the work principle of the present disclosure, if the gap between the rotor pin and the stator pin is equal to the design product diameter, the linear velocity V of the rotor post pin is between 5 m/s and 30 m/s, and the number of turns of the rotor pin and the stator pin is only 1-2 turns, the present disclosure has a good crushing function. The test and detection data of the prototype shows that compared with the existing crushing equipment, the disclosure has the obvious advantages of high efficiency, energy saving and less output of fine powdery materials.

In consideration of the fact that the existing shelling equipment is used to shell camellia seeds with different particle sizes and shapes, the shelling rate of one-time processing is less than 40%, but the crushing rate of camellia seeds is over 10%, and the shell of hickory is very strong, up to now, there is no equipment that can peel the shell of walnuts, and most of the camellia seed and hickory oil companies in China are crushing the oil with shells, according to the present disclosure, the gap between the rotor pin and the stator pin is designed to be approximately equal to the maximum particle diameter of the processed plant kernel, and the linear speed of the rotor column pin is between 2 m/s and 10 m/s. And it is an extruding-shearing sheller with only one turn of rotor pin and stator pin.

The distinguishing feature of the machine is that a rotor pin and a stator pin hold one or two plant fruits between them, exerting a huge crushing force and forcing the husk to break. According to the analysis of the structure and working principle of the present disclosure, there is no doubt that the present disclosure can husk camellia seeds and hickory nuts. The testing data of the prototype test shows that the husking rate of camellia seed can reach 95% and the breaking rate of the nut can be below 5% at the same time, obviously, the disclosure with superior husking function can greatly improve the oil yield and comprehensive economic benefits of oil pressing industries such as camellia seed and hickory nut, and greatly reduce the waste of valuable resources.

### BRIEF DESCRIPTION OF THE DRAWINGS

In order to more clearly explain the embodiments of the present disclosure or the technical solutions in the prior art, the following brief description will be given of the drawings which are required for use in the description of the embodiments or the prior art, obviously, the drawings in the following description are only the embodiments of the present disclosure, and for ordinary technicians in the field, other drawings can be obtained according to the provided drawings without paying creative efforts.

FIG. 1 is a structural schematic diagram provided by the present disclosure;

FIG. 2 is a front view of a schematic structural diagram of rotor pins or stator pins;

FIG. 3 is a top view of a schematic structural diagram of rotor pins or stator pins;

FIG. 4 is a schematic diagram of a relative position of rotor pins and stator pins;

FIG. 5 is a schematic diagram of the force in the extruding-shearing and crushing mode at the beginning of a pin crushing operation;

FIG. 6 is a schematic diagram of the force in the extruding-shearing and crushing mode in the middle stage of a pin crushing operation;

FIG. 7 is a schematic diagram of the force in the extruding-shearing and crushing mode at the end of a pin crushing operation;

In the drawings: 1. the casing; 2. the stator disk; 5. the stator pin; 6. the feed port; 8. the rotor pin; 9. the rotor disk; 10. the shaft cap; 11. the hub; 12. the motor; 15. the base; 16, the discharge port; 22. the wear-resistant components; 23 the pin billet.

### DETAILED DESCRIPTION OF THE EMBODIMENTS

The following will clearly and completely describe the technical scheme in the embodiment of the disclosure with reference to the drawings in the embodiment of the disclosure, obviously, the described embodiment is only a part of the embodiment of the disclosure, not all the embodiments. Based on the examples in this disclosure, all other examples obtained by ordinary technicians in this field without creative work are within the scope of protection of this disclosure.

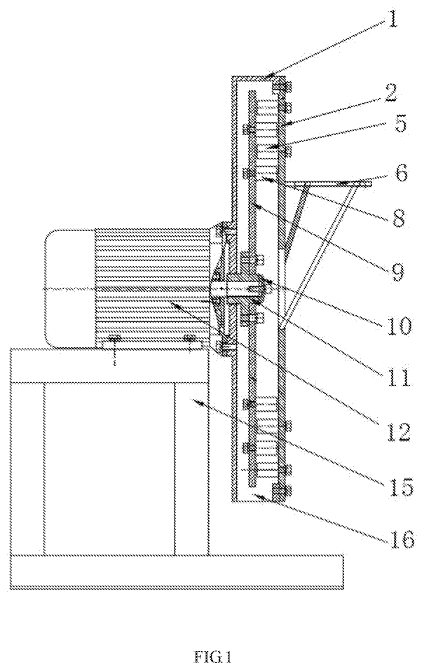

As shown in FIG. 1, a multifunctional extruding-shearing machine includes a motor 12, a casing 1, a base 15, a rotor part and a stator component-cum-cover plate. Wherein, the casing 1 is a disk-shaped casing with a high edge, a rectangular discharge port 16 is arranged below the casing 1, the left end face of the casing 1 is fixedly connected to the motor 12, the right end face of the casing 1 has an annular flange connected to a stator part, and a motor 12 is fixed to a base 15, and the rotor part is fixed to the shaft of the motor 12 through a hub 11 by means of a shaft cap 10 and bolts.

The rotor part includes a hub 11, a rotor disk 9 fixed on the hub 11, and one to three turns of several tens of the rotor pins 8 per turn mounted on the rotor disk 9, and the rotor pins 8 are uniformly distributed in a circumferential direction around the axis of the rotor disk 9.

The stator component-cum-cover plate includes a stator disk 2 and one to three turns of several tens of the stator pins 5 per turn mounted on the stator disk 2, the stator pins 5 are uniformly distributed in a circumferential direction around the axis of the stator disk 2, and the center of the stator part is provided with a feed port 6. The stator disk 2 doubles as a cover plate.

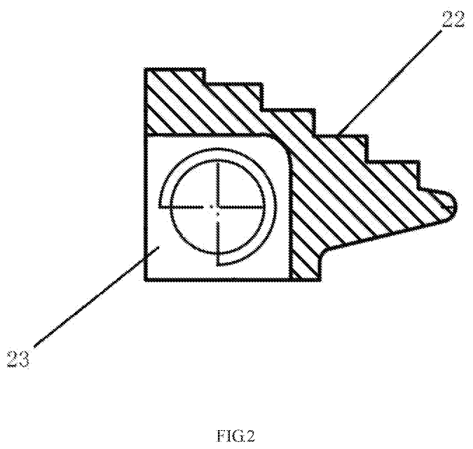

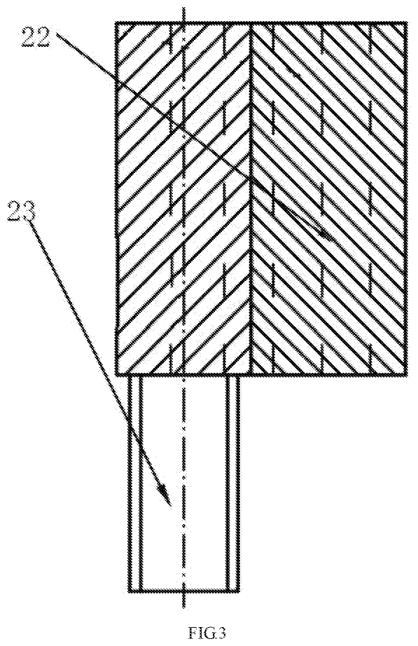

As shown in FIG. 2-3, the rotor pin 8 and the stator pin 5 have the same structure, and both of them include a quadrangular prismatic pin billet 23 and a wear-resistant member 22 welded or bonded to the pin billet 23. The wear-resistant member 22 is made of a cemented carbide or a special ceramic superhard wear-resistant material. The pin billet 23 is provided with a screw or polished rod connected with the rotor disk 9 or the stator disk 3. The inner horizontal surface and vertical surface of the wear-resistant member 22 are smooth planes, while the outer upper surface of the wear-resistant member 22 has 4-12 stepped teeth, and the lower surface consists of a right-angle table and a smooth slope, the inclined smooth plane of the lower surface merges with the lowest stepped surface of the upper surface in a spire shape, and the intersection is a transition of circular arc surface. The projected area of the outer upper surface of the wear-resistant member 22 in the vertical section passing through the axis of the pin billet 23 is more than three times that of the lower surface.

The horizontal and vertical sides of the inner side of the wear-resistant member 22 are welded or glued to the adjacent two sides of the quadrangular prismatic pin billet 23. The wear-resistant component 22 of the present disclosure is made of superhard wear-resistant materials such as hard alloy or special ceramics, and ensures that the service life of the present disclosure is 3-5 times longer than that of the existing similar equipment.

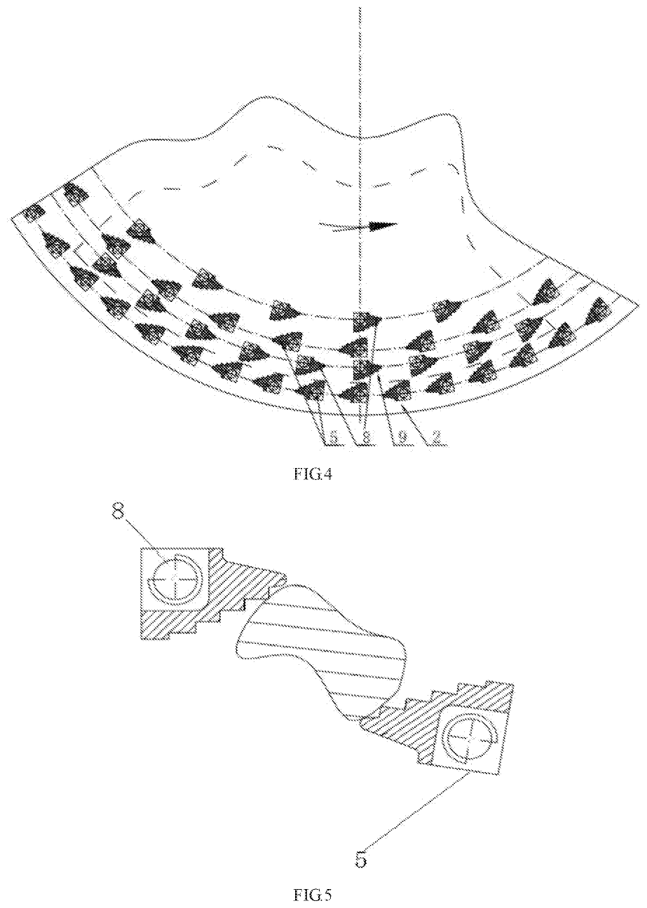

As shown in FIG. 4, when the disclosure is assembled, the stepped tooth surface of the stator pin 5 installed on the stator component faces inward, that is, the side close to the axis of the stator disk 2; the stepped tooth surface of the rotor pin 8 installed on the rotor component faces outward, that is, the side away from the axis of the rotor disk 9; and that step tooth tip of the rotor pin 8 face the step tooth tip of the stator pin 5. In other word, the side close to the axial center of the stator disk 2 and the side away from the axial center of the rotor disk,

In operation of the present disclosure, material enters the space between the stator disk 2 and the rotor disk 9 in the housing technology 1 through the feed port 6. When the rotor part rotates to drive the material particles into the narrow space between the rotor pin 8 and the stator pin 5, the rotor pin must exert a huge squeezing and shearing force on the material particles clamped between the rotor pin 8 and the stator pin 5, forcing the material to be broken. The crushed material passes through the gap between the two stator pins and then is discharged through the discharge port 16.

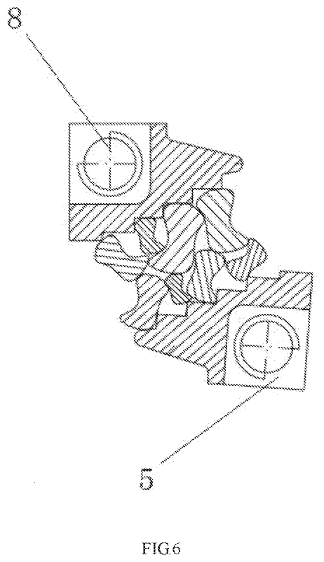

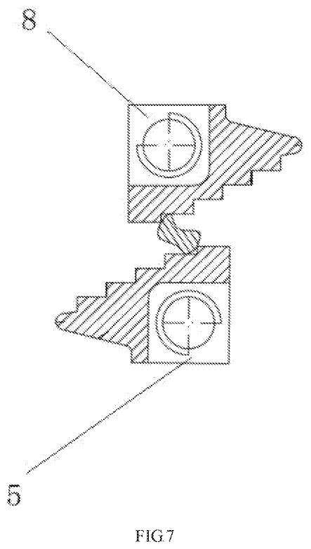

As shown in FIGS. 5-7, if the moment when a rotor pin 8 of the present disclosure approaches a stator pin 5 and leaves the stator pin 5 is regarded as a pin crushing operation, each pin crushing operation starts with the largest material particles clamped by the front step teeth of the rotor pin 8 and the stator pin 5. Since the rotor of the present disclosure operates at high speed so that each rotor pin 8 has a kinetic energy far exceeding the binding energy of the material particles, the largest material particles must be crushed rapidly. The state after the largest material particles have been crushed is shown in FIG. 6, the large and small material particles squeezed between the rotor pin 8 and the stator pin 5 are inevitably crushed successively by being subjected to the pressing and shearing forces exerted by the rotor pin 8, the stator pin 5 and the adjacent material particles. Until, as shown in FIG. 7, the material particles having a value slightly greater than L are crushed by clamping, in the foregoing, it is demonstrated that the extruding-shearing and crushing mode developed by the present disclosure and the high-speed extruding-shearing and crushing way has significant advantages such as huge force, extremely short operation time, extremely high crushing frequency and large crushing ratio.

An application of a. multifunctional extruding-shearing machine in a grinding equipment, a gap between the rotor pin and the stator pin is L, and the value of L is between 0.2 and 1.5 mm; a linear velocity v of the rotor pin is between 50 m/s and 150 m/s. According to the obvious advantages of the structure and action principle of the disclosure and the test data of the prototype, it is proved that the disclosure applied to the grinding equipment has the potential to replace most existing grinding equipment, and at the same time has great advantages such as simple structure, low price, small occupied area, convenient installation and maintenance, long service life, high efficiency and energy saving, etc.

An application of a multifunctional extruding-shearing machine in a crushing equipment, the value L of the gap between the rotor pin and the stator pin is equal to a product particle size value required by design; the linear velocity v of the rotor pin is between 5 m/s and 30 m/s. According to the obvious advantages of the structure and action principle of the disclosure and the test data of the prototype, it is proved that the application in a crushing equipment has obvious advantages such as high efficiency and energy saving.

An application of a multifunctional extruding-shearing machine, the value L of the gap between the rotor pin and the stator pin is equal to a maximum kernel diameter value of plants to be processed; the linear velocity v of the rotor pin is between 2 m/s and 10 m/s. According to the obvious advantages of the structure and action principle of the present disclosure and the test data of the prototype test, it is proved that the greatest advantage of the present disclosure applied to the peeling equipment is that it can peel the skins of camellia seeds and hickory nuts that are difficult to peel in the prior art, and it has remarkable economic benefits.

What is claimed is:

1. A multifunctional extruding-shearing machine, comprising:
a motor, a casing, a rotor part, a stator component-cum-cover plate, and a base,
wherein the casing is fixed on a flange plate of the motor and the motor is fixed on the base;
the rotor part comprises a hub, a rotor disk and rotor pins fixed on the hub,
wherein, the rotor pins are uniformly distributed and installed or welded on the rotor disk for one-three turns along a circumferential direction with an axis of the rotor disk as a center, and each turn is provided with a number of the rotor pins; the rotor disk is arranged in the casing and fixed on a rotating shaft of the motor through the hub;
the stator component-cum-cover plate comprises a stator disk and stator pins,
wherein, the stator pins are uniformly distributed and installed or welded on the stator disk for one-three turns along a circumferential direction with an axis of the stator disk as a center, and each turn is provided with a plurality of the stator pins; the center of the stator component-cum-cover plate is provided with a feed port, and the stator component-cum-cover plate is fixed on a surface of the casing;
the rotor pins and the stator pins have the same structure, and both of them comprise a quadrangular prismatic pin billet with a square cross section, and the pin billet is provided with a screw or a polished rod connected with the rotor disk or the stator disk; there are two surface welded or bonded wear-resistant members in a direct contact with a material on the quadrangular prismatic pin billet; wherein:
an inner horizontal surface and a vertical surface of the wear-resistant member are smooth planes, an outer upper surface of the wear-resistant member is composed of several stepped teeth, a lower surface is composed of a right-angle table and a smooth inclined plane, a smooth inclined plane of the lower surface merges with a lowest stepped surface of an upper surface in a spire shape, and a junction is a transition of an arc surface; a stepped tooth surface of the stator pin mounted on the stator component-cum-cover plate faces inward, a stepped tooth surface of the rotor pin mounted on the rotor part faces outward, and the stepped tooth tip of the rotor pin is disposed opposite to he stepped tooth tip of the stator pin.

2. The multifunctional extruding-shearing machine of claim 1, wherein a projected area of the upper surface on the outer side of the wear-resistant member in a vertical section passing through an axis of the pin billet is more than three times that of the lower surface.

3. The multifunctional extruding-shearing machine of claim 1, wherein the number of step teeth on the outer upper surface of the wear-resistant member is 4-12.

4. The multifunctional extruding-shearing machine of claim 1, wherein the wear-resistant member is made of a cemented carbide or a special ceramic superhard wear-resistant material.

5. The multifunctional extruding-shearing machine of claim 1, wherein, when applied to a grinding equipment, a gap between the rotor pin and the stator pin is 1, and the value of L is between 0.2 mm and 1.5 mm; a linear velocity v of the rotor pin is between 50 m/s and 150 m/s.

6. The multifunctional extruding-shearing machine of claim 1, wherein, when applied to a crushing equipment, the value L of the gap between the rotor pin and the stator pin is equal to a product particle size value required by design; the linear velocity v of the rotor pin is between 5 m/s and 30 m/s.

7. The multifunctional extruding-shearing machine of claim 1, wherein, when applied to a shelling equipment, the value L of the gap between the rotor pin and the stator pin is equal to a maximum kernel diameter value of plants to be processed; the linear velocity v of the rotor pin is between 2 m/s and 10 m/s.
